(19) United States
(12) Patent Application Publication
(10) Pub. No.: US 2006/0034099 A1
(43) Pub. Date: Feb. 16, 2006

(54) Light guide plate with V-shaped grooves and backlight module incorporating the same

(75) Inventors: Chiu-Lien Yang, Miao-Li (TW); Ching-Hung Teng, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/203,942

(22) Filed: Aug. 15, 2005

(30) Foreign Application Priority Data
Aug. 13, 2004 (TW) 93124353

(51) Int. Cl. F21V 7/04

(52) U.S. Cl. 362/615

(57) ABSTRACT

A light guide plate (10) of a preferred embodiment includes a substrate (11) and a refraction layer (12). The substrate includes an incident surface (18) for receiving incident light beams from a corresponding light source, an emitting surface (14), and a bottom surface opposite to each other. A plurality of V-shaped grooves being defined at the emitting surface and at the bottom surface. A side of each V-shaped groove of the bottom surface defines a curved surface, and at least one part of the curved surface is wave-shaped. The refraction layer is on the emitting surface. The light guide plate can improve the utilization of light beams and reduce wastage of light beams.

### FIELD OF THE INVENTION

The present invention relates to a light guide plate employed in a backlight module, and particularly to a light guide plate having V-shaped grooves configured for high and uniform brightness.

### BACKGROUND

Because a liquid crystal display (LCD) device has the advantages of being thin, light in weight, and drivable by a low voltage, it is extensively employed in various electronic devices.

A liquid crystal panel of an LCD device can not itself emit light beams. Therefore a typical liquid crystal panel uses a backlight module to provide the needed illumination. The backlight module has a light source and a light guide plate. The light source emits the light beams to the light guide plate, which then transmits light beams to illuminate the liquid crystal panel.

Referring to FIG. 18, a typical backlight module 1 includes a light guide plate 2 and a light source 3. The light guide plate 2 has a bottom surface 5 and an emitting surface 4. The light source 3 is set adjacent one corner of the light guide plate 2. A plurality of parallel, V-shaped grooves 6 is defined at the bottom surface 5. The V-shaped grooves 6 are arc-shaped. For each V-shaped groove 6, every point along an apex of the V-shaped groove 6 is substantially equidistant from the light source 3. The V-shaped grooves 6 all have a same width and a same height. More particularly, density of the V-shaped grooves 6 is uniform along a direction away from the light source 3.

When light beams from the light source 3 strike surface of the light guide plate 2 at the V-shaped grooves 6, the incident angles of the light beams differ according to the heights at which the light beams reach the V-shaped grooves 6. In other words, some incident angles are relatively large and some incident angles are relatively small.

When the incident angles are large, the light beams typically are reflected from the surface at the V-shaped groove 6, whereupon the light beams emit from the emitting surface 4. Such light beams are not refracted at the surface.

In contrast, when the incident angles are small, the light beams typically are reflected and also refracted from the surface at the V-shaped groove 6. The refracted light beams are wasted. Thus the overall utilization of light beams by the light guide plate is lowered, and illumination provided by the emitting surface 4 is liable to be non-uniform.

It is desired to provide a new light guide plate and a corresponding backlight module which overcome the above-described problems.

### SUMMARY

In one embodiment, a light guide plate includes a substrate and a refraction layer. The substrate includes an incident surface for receiving incident light beams from a corresponding light source, an emitting surface and a bottom surface opposite to each other. A plurality of V-shaped grooves is defined at the emitting surface and at the bottom surface. A side of each V-shaped groove of the bottom surface defines a curved surface, and at least one part of the curved surface is wave-shaped. The refraction layer is on the emitting surface.

Because the sides of each V-shaped groove are curved surfaces and at least one part of the curved surfaces are wave-shaped, when the light beams reach the V-shaped grooves, the incident angles differ along the sides of the grooves. By configuring the curvature of the V-shaped grooves, the light guide plate can accommodate the incident angles, to ensure that the incident angles are sufficient to be reflected by the sides of the grooves and not refracted. Thus, the utilization of the light beams is improved. The light beams are concentrated by the V-shaped grooves and subsequently emit from the refraction layer. Consequently, the light guide plate can provide high luminance.

Other advantages and novel features will become more apparent from the following detailed description when taken in conjunction with the accompanying drawings.

### BRIEF DESCRIPTION OF THE DRAWINGS

FIG. 1 is a top plan view of a light guide plate according to a first embodiment of the present invention.

FIG. 2 is a bottom plan view of the light guide plate of FIG. 1.

FIG. 3 is a side plan view of the light guide plate of FIG. 1.

FIG. 4 is a schematic, enlarged, isometric view of part of a V-shaped groove at bottom surface of the light guide plate of FIG. 1.

FIG. 5 is a schematic, cross-sectional view of part of inside surface of the V-shaped groove of FIG. 4.

FIG. 6 is a schematic, side plan view of part of top line defined by the V-shaped groove of FIG. 4.

FIG. 7 is a bottom plan view of a light guide plate according to a second embodiment of the present invention.

FIG. 8 is a side plan view of the light guide plate of FIG. 7.

FIG. 9 is a schematic, enlarged, isometric view of part of a V-shaped groove at bottom surface of the light guide plate of FIG. 7.

FIG. 10 is a top plan view of a light guide plate according to a third embodiment of the present invention.

FIG. 11 is a schematic, enlarged, isometric view of part of a V-shaped groove at the bottom surface of the light guide plate according to the third embodiment of the present invention.

FIG. 12 is a bottom plan view of a light guide plate according to a fourth embodiment of the present invention.

FIG. 13 is a schematic, enlarged, isometric view of part of a V-shaped groove at the bottom surface of the light guide plate of FIG. 12.

FIG. 14 is a top plan view of a light guide plate according to a fifth embodiment of the present invention.

FIG. 15 is a bottom plan view of the light guide plate of FIG. 14.

FIG. 16 a side plan view of the light guide plate of FIG. 14.

FIG. 17 is a bottom plan view of a light guide plate according to a sixth embodiment of the present invention.

FIG. 18 is a schematic, isometric view of a conventional backlight module.

### DETAILED DESCRIPTION OF PREFERRED EMBODIMENTS

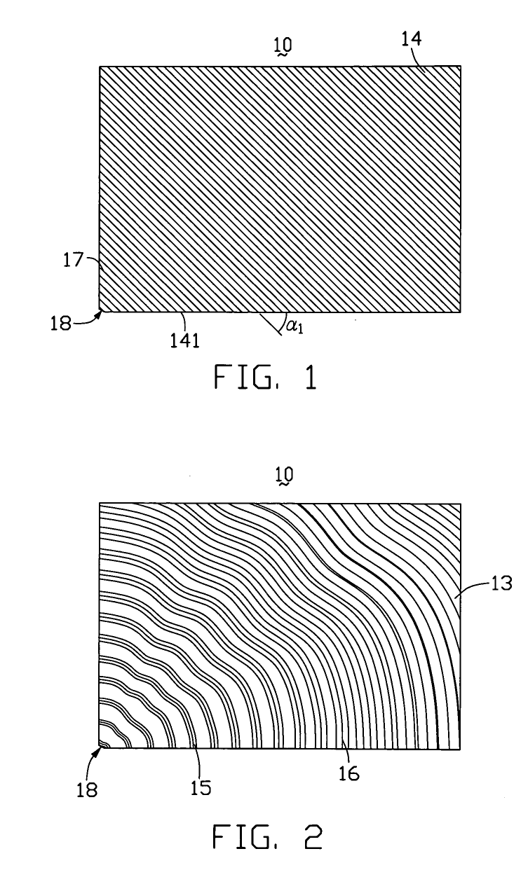

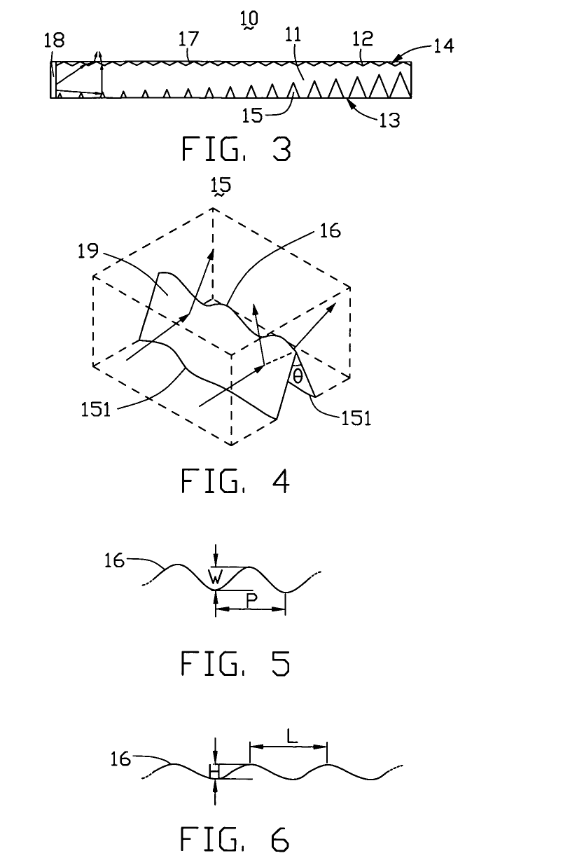

Referring to FIGS. 1 to 3, a light guide plate 10 according to the first embodiment of the present invention is shown. The light guide plate 10 includes a substrate 11, and a refraction layer 12.

The substrate 11 includes an incident surface 18, a bottom surface 13, and an emitting surface 14 opposite to the bottom surface 13. The incident surface 18 is at a comer of the light guide plate 10, and adjoins the bottom surface 13. The bottom surface 13 has a plurality of parallel, V-shaped grooves 15. The V-shaped grooves 15 become progressively more densely arranged along a direction away from the incident surface 18. In addition, heights of the V-shaped grooves 15 become progressively greater along a direction away from the incident surface 18. The V-shaped grooves 15 are wavy, as viewed from a bottom of the light guide plate 10.

The emitting surface 14 also includes a plurality of V-shaped grooves 17. The V-shaped grooves 15 are rectilinear, as viewed from a top of the light guide plate 10. The V-shaped grooves 15 maintain an angle α1 relative to a long side 141 of the emitting surface 14. In the illustrated embodiment, α1 is 40 degrees.

The refraction layer 12 is arranged on the emitting surface 14, and a refractive index of the refraction layer 12 is larger than that of the light guide plate 10.

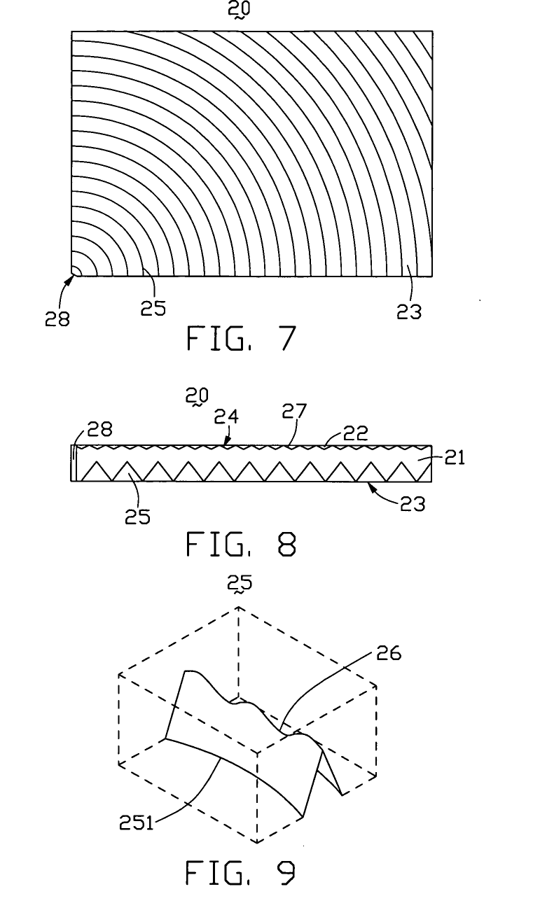

Referring to FIG. 4, part of a V-shaped groove 15 according to the first embodiment is shown. Each V-shaped groove 15 defines two sides 19, a top line 16 where the sides 19 intersect, two bottom lines 151 at bottom extremities of the sides 19 respectively, and an angle θ between the sides 19. Each side 19 of the V-shaped groove 15 has a curved surface, and at least one part of the curved surface is wave-shaped. In a simple exemplary embodiment, the entire curved surface is wave-shaped. Referring also to FIGS. 5 and 6, the wave-shaped surface defines a width W and a wavelength P. The top line 16 of the V-shaped groove 15 is a wave-shaped line, which defines a height H and a wavelength L. Each bottom line 151 is also a wave-shaped line.

In use, by configuring either or both of the width W and the wavelength P of any side 19 of the V-shaped groove 15, the size of the angle θ of the V-shaped groove 15 can be configured accordingly. This in turn determines the incident angle of light beams striking the side 19. If the incident angle is large enough, the light beams can be reflected by the side 19 instead of being refracted. This technique improves the utilization of light beams by the light guide plate 10, and reduces wastage of light beams.

By configuring either or both of the height H and the wavelength L of the top line 16, the uniformity of luminance of the light guide plate 10 can be configured accordingly. In particular, it is desirable that the height H of the V-shaped grooves 15 progressively increase in a direction away from the incident surface 18, such that the heights of the V-shaped grooves 15 progressively increase in a direction away from the incident surface 18. In this way, the density of the V-shaped grooves 15 can progressively increase along a direction away from the incident surface 18. Thus, the light guide plate 10 can provide uniform luminance.

In use, after being reflected by the V-shaped grooves 15, the light beams emit to the V-shaped grooves 17 and then to the refraction layer 12. Because the refractive index of the refraction layer 12 is larger than that of the light guide plate 10, some of the light beams are totally reflected between the V-shaped grooves 17 and the refraction layer 12. In this way the light beams are thus concentrated by the V-shaped grooves 17, and eventually emit from the refraction layer 12. Consequently, the light guide plate 10 can provide high luminance.

Referring to FIG. 7 and FIG. 8, a light guide plate 20 according to the second embodiment of the present invention. Similar to the light guide plate 10 of the first embodiment, the light guide plate 20 includes a substrate 21 and a refraction layer 22. The substrate 21 has an incident surface 28, an emitting surface 24, and a bottom surface 23. The incident surface 28 is at a comer of the light guide plate 20. The emitting surface 24 has a plurality of parallel, V-shaped grooves 27. The V-shaped grooves 27 are rectilinear, as viewed from a top of the light guide plate 20. The V-shaped grooves 27 maintain an angle (α2, not shown) relative to a long side of the light guide plate 20. In the illustrated embodiment, α2 is 45 degrees. The bottom surface 23 has a plurality of parallel, V-shaped grooves 25. The V-shaped grooves 25 are arc-shaped, as viewed from a bottom of the light guide plate 20. For each V-shaped groove 25, every point along an apex of the V-shaped groove 25 is substantially equidistant from the incident surface 28. The V-shaped grooves 25 all have a same width and a same height. More particularly, a density of the V-shaped grooves 25 is uniform along a direction away from the incident surface 28.

FIG. 9 illustrates part of a V-shaped groove 25 according to the second embodiment. The V-shaped groove 25 defines two sides, a top line 26, and two bottom lines 251. Unlike the V-shaped groove 15 of the first embodiment, the bottom lines 251 of the V-shaped groove 25 are both arc-shaped.

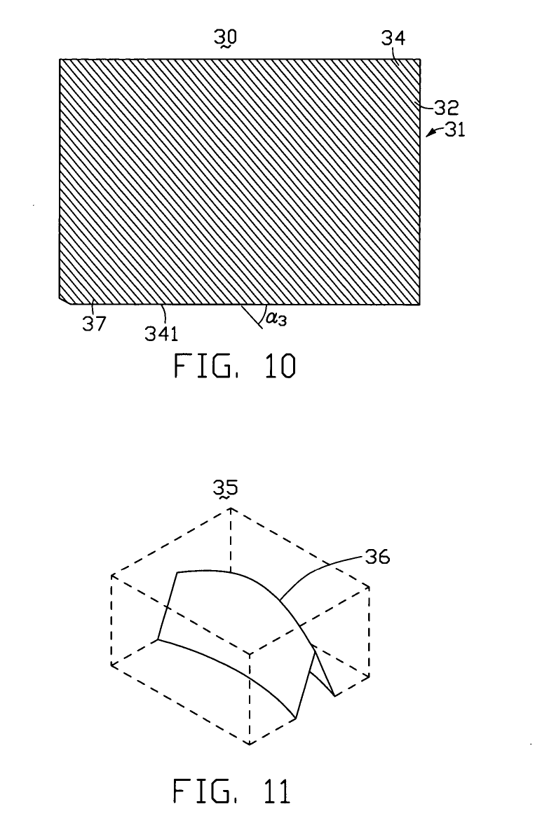

Referring to FIG. 10, this shows a light guide plate 30 according to the third embodiment of the present invention. Similar to the light guide plate 20 of the second embodiment, the light guide plate 30 includes a substrate 31 and a refraction layer 32. FIG. 11 is a schematic, enlarged, isometric view of part of a V-shaped groove at a bottom surface of the light guide plate 30. Similar to the light guide plate 20, the substrate 31 has an emitting surface 34 and a bottom surface (not shown). The emitting surface 34 has a plurality of V-shaped grooves 37. The V-shaped grooves 25 are rectilinear, as viewed from a top of the light guide plate 30. The V-shaped grooves 37 maintain an angle α3 relative to a long side 341 of the light guide plate 30. In the illustrated embodiment, α3 is 50 degrees.

The bottom surface has a plurality of parallel, V-shaped grooves 35. The V-shaped grooves 35 are arc-shaped, as viewed from a bottom of the light guide plate 30. FIG. 11 illustrates part of a V-shaped groove 35 according to the third embodiment. The V-shaped groove 35 defines a top line 36. Unlike the V-shaped groove 15 of the light guide plate 10 of the first embodiment, the top line 36 is arc-shaped.

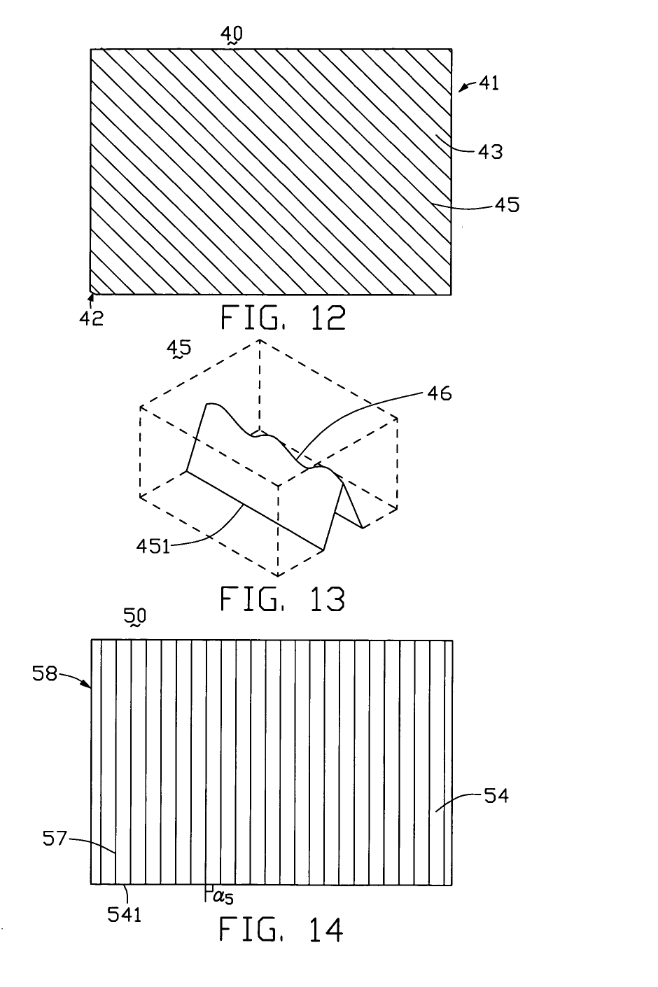

Referring to FIG. 12, a light guide plate 40 according to the fourth embodiment of the present invention is shown. The light guide plate 40 includes a substrate 41, and a refraction layer (not visible) arranged on an emitting surface (not visible). The substrate 41 has an incident surface 42 and a bottom surface 43. The incident surface 42 is at a corner of the light guide plate 40. The bottom surface 41 has a plurality of parallel, V-shaped grooves 45. The V-shaped grooves 45 are rectilinear, as viewed from a bottom of the light guide plate 40. A density of the V-shaped grooves 43 is uniform along a direction away from the incident surface 42.

FIG. 13 illustrates part of a V-shaped groove 45 according to the fourth embodiment. The V-shaped groove 45 defines two sides, a top line 46, and two bottom lines 451. The top line 46 is a wave-shaped line. Unlike the V-shaped groove 35 of the light guide plate 30 of the third embodiment, the bottom lines 451 of the V-shaped groove 45 are both rectilinear.

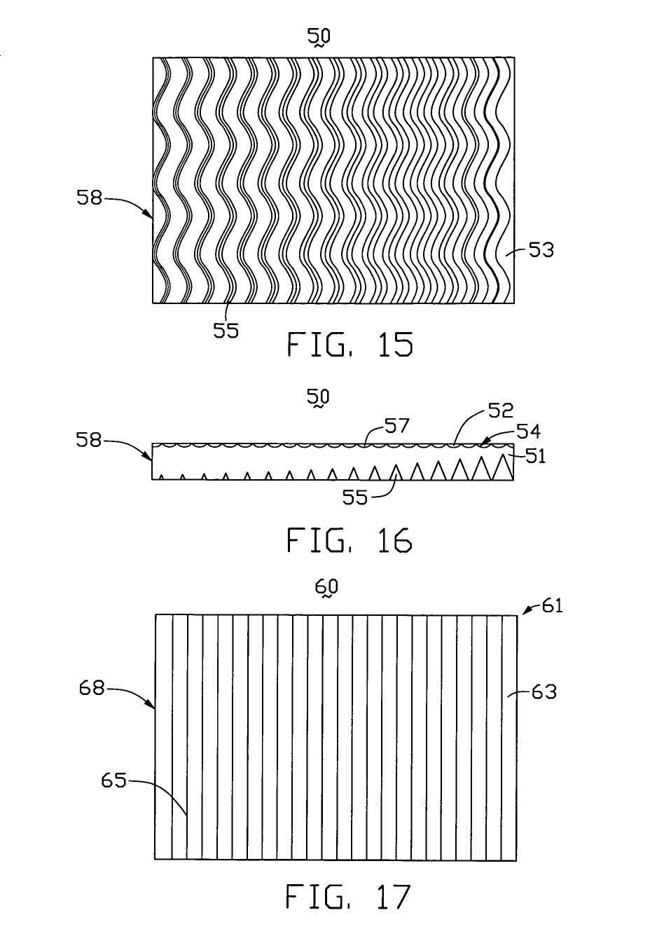

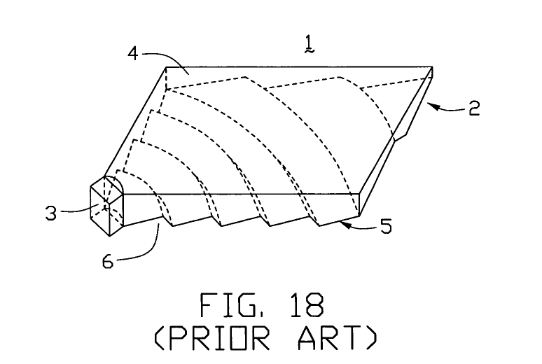

Referring to FIGS. 14 to 16, a light guide plate 50 according to the fifth embodiment of the present invention is shown. The light guide plate 50 includes a substrate 51 having an emitting surface 54, and a refraction layer 52 arranged on the emitting surface 54. The incident surface 58 of the substrate 51 is at an entire main side of the light guide plate 50. The substrate 51 also has an incident surface 58 and a bottom surface 53. A plurality of parallel, the V-shaped grooves 57 is defined at the emitting surface 54. The V-shaped grooves 57 are rectilinear, as viewed from a top of the light guide plate 50. The V-shaped grooves 57 maintain an angle α5 relative to a long side 541 of the light guide plate 50. In the illustrated embodiment, α5 is 90 degrees. That is, the V-shaped grooves 57 are parallel to the incident surface 58.

The bottom surface 53 has a plurality of parallel V-shaped grooves 55. The V-shaped grooves 55 are wavy, as viewed from a bottom of the light guide plate 50. The V-shaped grooves 55 are parallel to the incident surface 58. A density of the V-shaped grooves 55 progressively increases along a direction away from the incident surface 58. Top and bottom lines (none labeled) defined by the V-shaped grooves 55 are all wave-shaped.

Referring to FIG. 17, a light guide plate 60 according to the sixth embodiment of the present invention is shown. The light guide plate 60 includes a substrate 61, and a refraction layer (not visible) arranged on an emitting surface (not visible) of the substrate 61. An incident surface 68 of the substrate 61 is at an entire main side of the light guide plate 60. A plurality of parallel, V-shaped grooves 65 is defined at a bottom surface 63 of the substrate 61. The V-shaped grooves 65 are rectilinear, as viewed from a bottom of the light guide plate 60. The V-shaped grooves 65 are parallel to the incident surface 68. Unlike the light guide plate 50 of the fifth embodiment, a density of the V-shaped grooves 65 is uniform along a direction away from the incident surface 68.

Various modifications and alterations are possible within the ambit of the invention herein. For example, the angle that the V-shaped grooves of the emitting surface maintain relative to the long side of the light guide plate may be varied. For example, the angle may be in the range from 40˜50 degrees, or in the range from 85˜90 degrees.

It is to be further understood that even though numerous characteristics and advantages of various embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate, comprising:
a substrate comprising an incident surface for receiving incident light beams from a corresponding light source, and an emitting surface and a bottom surface opposite to each other, a plurality of V-shaped grooves being defined at the emitting surface and at the bottom surface, and a side of each V-shaped groove of the bottom surface defining a curved surface, wherein at least one part of the curved surface is wave-shaped; and
a refraction layer provided at the emitting surface.

2. The light guide plate as claimed in claim 1, wherein each V-shaped groove of the bottom surface defines a top line, and the top line is curved.

3. The light guide plate as claimed in claim 1, wherein each V-shaped groove of the bottom surface defines two bottom lines, and at least one of the bottom lines is curved.

4. The light guide plate as claimed in claim 1, wherein each V-shaped groove of the bottom surface defines two bottom lines, and the bottom lines are rectilinear.

5. The light guide plate as claimed in claim 1, wherein a density of the V-shaped grooves of the bottom surface progressively increases along a direction away from the incident surface.

6. The light guide plate as claimed in claim 1, wherein a height of the V-shaped grooves of the bottom surface progressively increases in a direction away from the incident surface.

7. The light guide plate as claimed in claim 1, wherein a refractive index of the refraction layer is larger than that of the light guide plate.

8. The light guide plate as claimed in claim 1, wherein the V-shaped grooves of the emitting surface maintain an angle relative to a main side of the light guide plate, and the angle is in the range from 40˜50 degrees or in the range from 85˜90 degrees.

9. The light guide plate as claimed in claim 8, wherein the angle is 40 degrees.

10. The light guide plate as claimed in claim 8, wherein the angle is 45 degrees.

11. The light guide plate as claimed in claim 8, wherein the angle is 50 degrees.

12. The light guide plate as claimed in claim 8, wherein the angle is 90 degrees.

13. A backlight module, comprising:
a light source; and
a light guide plate comprising a substrate and a refraction layer, the substrate comprising an emitting surface and a bottom surface opposite to each other, a plurality of V-shaped grooves being defined at the emitting surface and at the bottom surface, a side of each V-shaped groove of the bottom surface defining a curved surface, at least one part of the curved surface being wave-shaped, and the refraction layer being at the emitting surface.

14. The backlight module as claimed in claim 13, wherein each V-shaped groove of the bottom surface defines a top line, and the top line is curved.

15. The backlight module as claimed in claim 13, wherein a density of the V-shaped grooves of the bottom surface progressively increases along a direction away from the incident surface.

16. The backlight module as claimed in claim 13, wherein a height of the V-shaped grooves of the bottom surface progressively increases in a direction away from the incident surface.

17. The backlight module as claimed in claim 13, wherein a refractive index of the refraction layer is larger than that of the light guide plate.

18. The backlight module as claimed in claim 13, wherein the V-shaped grooves of the emitting surface define an angle relative to a main side of the light guide plate, and the angle is in the range from 40˜50 degrees or in the range from 85˜90 degrees.

19. A backlight module, comprising:
a light source; and
a light guide plate comprising a substrate, the substrate comprising an emitting surface and a bottom surface opposite to each other, a plurality of upside-down V-shaped grooves being defined in the bottom surface, a bottom edge of each of said V-shaped grooves defining a serpentine configuration not only in a vertical direction perpendicular to the bottom surface but also in a horizontal direction parallel to the bottom surface.

20. The backlight module as claimed in claim 19, wherein a refraction layer is applied to the emitting surface.
